(19) United States
(12) Patent Application Publication
(10) Pub. No.: US 2023/0316811 A1
(43) Pub. Date: Oct. 5, 2023

(54) SYSTEM AND METHOD OF IDENTIFYING A PHYSICAL EXERCISE

(71) Applicant: AGADO LIVE LTD., Ramat Hasharon (IL)

(72) Inventors: Vittaly TAVOR, Ramat Hasharon (IL); Tzach GOREN, Herzelia (IL); Gili YARON, Ramat Hasharon (IL)

(73) Assignee: AGADO LIVE LTD., Ramat Hasharon (IL)

(21) Appl. No.: 18/131,011

(22) Filed: Apr. 5, 2023

Related U.S. Application Data
(60) Provisional application No. 63/327,373, filed on Apr. 5, 2022.

(51) Int. Cl. G06V 40/20; G06T 17/00; G06V 10/82; G06T 7/246

(52) U.S. Cl. CPC G06V 40/23; G06T 17/00; G06V 10/82; G06T 7/248; G06T 2207/20084; G06T 2207/30196

(57) ABSTRACT

Systems and methods of identifying a physical exercise, including: imaging a user's body, determining reference points on the user's body using image processing, applying a machine learning algorithm to identify a repetition of movement of the determined reference points within a sequence of frames received from the imager, clustering the identified repetition for at least two different users to outline a potential physical exercise based on movement of the reference points, and verifying the outline as a physical exercise.

### CROSS REFERENCE TO RELATED APPLICATIONS

This application claims the benefit of U.S. Provisional Patent Application No. 63/327,373, filed Apr. 5, 2022, the entire content of which is incorporated herein by reference in its entirety.

### FIELD OF THE INVENTION

The present invention relates to computer vision and image processing. More specifically, the present invention relates to systems and methods for physical exercise identification, and correction during remote participation in the physical exercise.

### BACKGROUND

In recent years, various online wellness activities have become very popular and used by many users, while previously have been thought of as in-person only. Some examples are functional training sessions, yoga, dancing, physiotherapy.

In the subsequent text the term “practitioner” is used to refer to instructors, trainers and all other wellness professionals.

One approach to such activities is fully automatic guidance, with a dedicated application giving instructions on what to do (e.g., offering some correction of the performance). Such an application may for instance require dedicated hardware. While following the guidance, the application may create an impression of being in a team, but being unable to select friends to be with, and cannot communicate with fellow participants. Also, the recommendations and/or the correction provided by the automatic guidance is not sufficiently personalized, taking into account only general parameters, like age, weight, height, etc.

Another approach to such activities is recorded content. A practitioner records a session, to be watched and followed by others. The user has zero guidance, and being trained alone where the content is not personalized for the user's abilities.

Yet another approach to such activities is live content. There's a practitioner, there's a team training together, at the same time. In live sessions the practitioners are using tools which were primarily designed for video conferencing. These tools are not suited for movement and using these tools the practitioners cannot control more than 3-5 participants. With more participants it becomes very similar to recorded content. But even for a small number of participants the practitioner has difficulty tracking the performance of the participants, providing any meaningful guidance or personal approach. In all of these approaches, the number of injuries among the participants is much higher than during in-person activities due to a lack of personal attention and/or guidance, where the participant churn rate is very high due to inadequate experience.

### SUMMARY OF THE INVENTION

Systems and methods are provided to optimize the way such activities should be carried out, by taking the best of all these approaches and adding logic to augment the experience of both the practitioner and the participant.

There is thus provided, in accordance with some embodiments of the invention a method of method of translating a two-dimensional (2D) image into a three-dimensional (3D) model, including: imaging, by an imager, a user's body, determining, by a processor, reference points on the user's body using image processing, and applying, by the processor, a machine learning (ML) algorithm to translate the determined reference points on a 2D image of the user's body from the imager into a 3D model of the reference points. In some embodiments, the 3D model is determined based on a known relation between the reference points of the user's body.

In some embodiments, the ML algorithm includes self-supervised learning using a generative adversarial network (GAN) algorithm. In some embodiments, the 2D image is rotated such that a predefined point of the reference points is at the center of a 3D coordinate system.

In some embodiments, the determined reference points are scaled so that the distance between each pair of reference points corresponds to the 3D coordinate system. In some embodiments, the imager is a single RGB camera, and wherein the imaging is carried out to capture images of a plurality of angles of the user's body.

There is thus provided, in accordance with some embodiments of the invention a method of identifying a physical exercise, including: imaging, by an imager, a user's body, determining, by a processor, reference points on the user's body using image processing, applying, by the processor, a machine learning (ML) algorithm to identify a repetition of movement of the determined reference points within a sequence of frames received from the imager, clustering, by the processor, the identified repetition for at least two different users to outline a potential physical exercise based on movement of the reference points; and verifying the outline as a physical exercise.

In some embodiments, the ML algorithm is based on at least one of: a recurrent neural network (RNN) and a temporal self-similarity matrix (TSM). In some embodiments, the ML algorithm is to identify repetition of motionless of the determined reference points within a sequence of frames received from the imager as a potential physical exercise.

In some embodiments, instructions for a correct execution of the verified physical exercise are received, an inefficiency score is calculated based on weighted average distance of the reference points from the correct execution, and a suggestion to correct the user's posture is provided by moving at least one reference point, when the inefficiency score exceeds a posture threshold. In some embodiments, the posture threshold is based on a deviation from a normalized average of different users carrying out the verified physical exercise.

In some embodiments, each verified physical exercise is stored in a dedicated database to be compared to future exercises. In some embodiments, a new repetition of movement is determined as corresponding to the physical exercise from the dedicated database.

In some embodiments, instructions for a correct execution of the verified physical exercise are received, at least one extreme movement point is determined during the verified physical exercise, and an alert is issued when the determined at least one extreme movement point is reached below a predefined fatigue threshold.

In some embodiments, an alert is issued when a tremor movement is detected over a predefined time period. In some embodiments, an alert is issued when at least one of the following conditions is detected incorrect posture, concentration impairment, and exaggerated exertion.

In some embodiments, the predefined fatigue threshold is based on a fatigue database comprising a plurality of conditions, postures, and movements associated with a state of fatigue.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows a block diagram of an example computing device, according to some embodiments of the invention;

FIG. 2 shows a schematic block diagram of a system for identifying a physical exercise, according to some embodiments of the invention;

FIG. 3 shows a schematic illustration of identification of reference points, according to some embodiments of the invention;

FIG. 4 shows a schematic illustration of identification of reference points from different angles of the body, according to some embodiments of the invention;

FIGS. 5A and 5B show a schematic illustration of scaling of reference points to a single canonical unit, according to some embodiments of the invention;

FIGS. 6A and 6B show a flowchart for an algorithm of identifying a set of frames as a potential exercise, according to some embodiments of the invention;

FIGS. 7A-7B show a schematic illustration of a repetition outline, according to some embodiments of the invention;

FIG. 8A show a translation of an image to a subset of points, according to some embodiments of the invention;

FIG. 8B illustrates points to compare, according to some embodiments of the invention;

FIG. 9 show a schematic illustration of a correction suggestion, according to some embodiments of the invention; and

FIG. 10 shows a flowchart for a method of identifying a physical exercise, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof may occur or be performed simultaneously, at the same point in time, or concurrently.

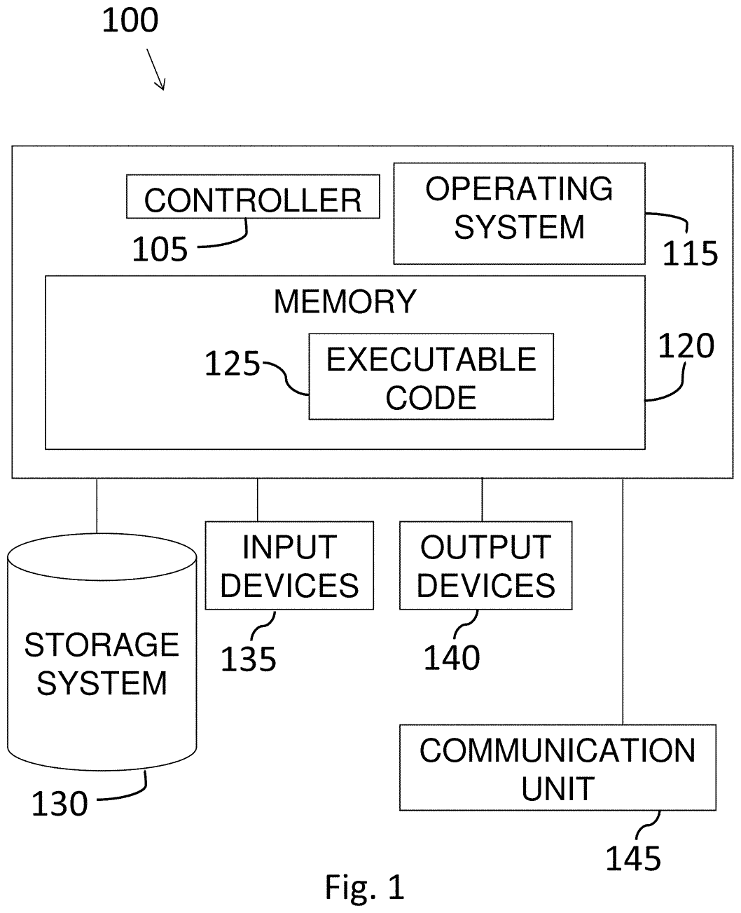

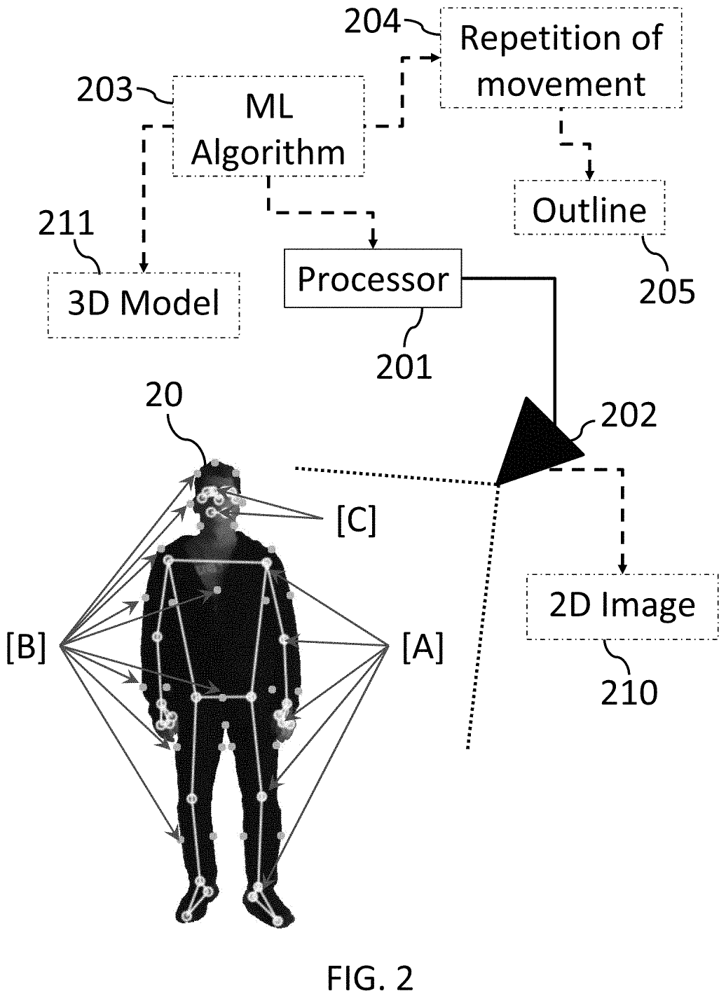

Reference is made to FIG. 1, which is a schematic block diagram of an example computing device, according to some embodiments of the invention. Computing device 100 may include a controller or processor 105 (e.g., a central processing unit processor (CPU), a chip or any suitable computing or computational device), an operating system 115, memory 120, executable code 125, storage 130, input devices 135 (e.g. a keyboard or touchscreen), and output devices 140 (e.g., a display), a communication unit 145 (e.g., a cellular transmitter or modem, a Wi-Fi communication unit, or the like) for communicating with remote devices via a communication network, such as, for example, the Internet. Controller 105 may be configured to execute program code to perform operations described herein. The system described herein may include one or more computing device(s) 100, for example, to act as the various devices or the components shown in FIG. 2. For example, components of system 200 may be, or may include computing device 100 or components thereof.

Operating system 115 may be or may include any code segment (e.g., one similar to executable code 125 described herein) designed and/or configured to perform tasks involving coordinating, scheduling, arbitrating, supervising, controlling or otherwise managing operation of computing device 100, for example, scheduling execution of software programs or enabling software programs or other modules or units to communicate.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of similar and/or different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be a software application that performs methods as further described herein. Although, for the sake of clarity, a single item of executable code 125 is shown in FIG. 1, a system according to embodiments of the invention may include a plurality of executable code segments similar to executable code 125 that may be stored into memory 120 and cause controller 105 to carry out methods described herein.

Storage 130 may be or may include, for example, a hard disk drive, a universal serial bus (USB) device or other suitable removable and/or fixed storage unit. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a keyboard, a touch screen or pad, one or more sensors or any other or additional suitable input device. Any suitable number of input devices 135 may be operatively connected to computing device 100. Output devices 140 may include one or more displays or monitors and/or any other suitable output devices. Any suitable number of output devices 140 may be operatively connected to computing device 100. Any applicable input/output (I/O) devices may be connected to computing device 100 as shown by blocks 135 and 140. For example, a wired or wireless network interface card (NIC), a universal serial bus (USB) device or external hard drive may be included in input devices 135 and/or output devices 140.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 120, computer-executable instructions such as executable code 125 and a controller such as controller 105. Such a non-transitory computer readable medium may be for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including, semiconductor devices such as read-only memories (ROMs) and/or random-access memories (RAMs), flash memories, electrically erasable programmable read-only memories (EEPROMs) or any type of media suitable for storing electronic instructions, including programmable storage devices. For example, in some embodiments, memory 120 is a non-transitory machine-readable medium.

A system according to embodiments of the invention may include components such as, but not limited to, a plurality of central processing units (CPUs), a plurality of graphics processing units (GPUs), or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, or any other suitable computing device. For example, a system as described herein may include one or more facility computing device 100 and one or more remote server computers in active communication with one or more facility computing device 100 such as computing device 100, and in active communication with one or more portable or mobile devices such as smartphones, tablets and the like.

Reference is made to FIG. 2, which is a schematic block diagram of a system 200 for identifying a physical exercise, according to some embodiments of the invention. In FIG. 2, hardware elements are indicated with a solid line and the direction of arrows indicate a direction of information flow between the hardware elements.

The system 200 may include a processor 201 (e.g., such as controller 105, shown in FIG. 1) in communication with an imager 202 (e.g., an RGB camera) that is configured to image a user's body 20. The user may be a participant of physical exercises and use the system 200 for monitoring and/or guidance based on experience of trained practitioners, as further described hereinafter. For example, the system 200 may provide a virtual instructor/trainer able to provide most of the needed personalized guidance, while alerting the real, human practitioner when the personal attention is required.

In some embodiments, the processor 201 is configured to determine a plurality of reference points (e.g., shown for torso, dace and limbs points [A], [B], [C]) on the user's body 20 using image processing. The processor 201 may apply a machine learning (ML) algorithm 203 to identify a repetition of movement 204 of the determined reference points [A], [B], [C] within a sequence of frames received from the imager 202.

According to some embodiments, the processor 201 is configured to cluster the identified repetition 204 for at least two different users to outline 205 a potential physical exercise based on movement of the reference points [A], [B], [C]. In some embodiments, the outline 205 may be provided to at least one practitioner for verification as a physical exercise.

For example, the practitioner may conduct remote sessions (e.g., live or recorded) to a large number of participants without sacrificing the quality of the instruction and allowing full personalization.

The system 200 may be trained and setup in an initial preparation stage with model training for reference point detection and/or definition of known exercises (to create an exercise dictionary). In some embodiments, for each subject, for example a human body, reference points may be defined needed for subsequent processing.

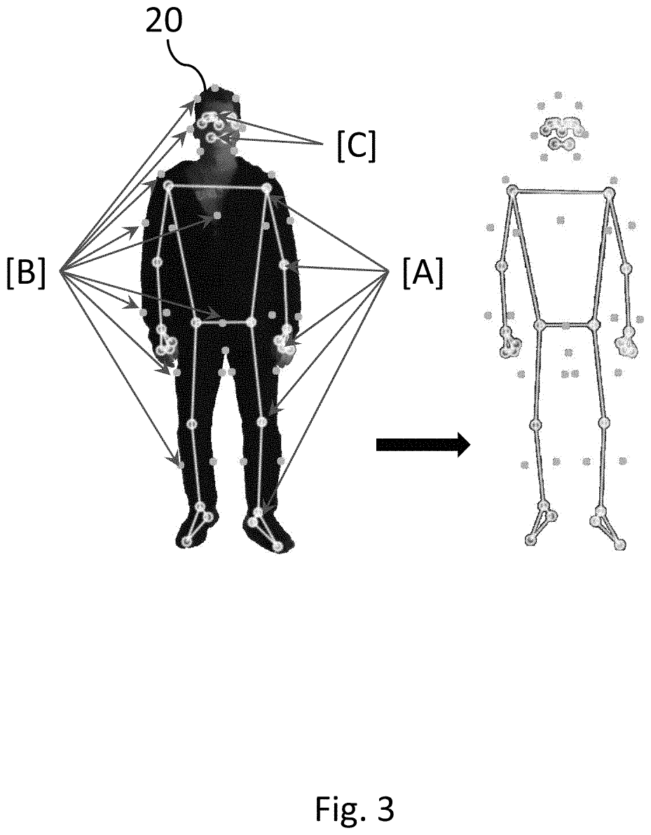

Reference is made to FIG. 3, which is a schematic illustration of identification of reference points, according to some embodiments of the invention. In FIG. 3 there are three types of reference points: [A] with joint reference points (connected by lines when possible), [B] with facial features reference points (e.g., eyes, nose, etc), and [C] with body density reference points, located in body key locations and allowing to assess body properties: width of shoulders, width and length of limbs, etc.

In order to get a reference image, pictures of multiple subjects standing face to the camera may be taken, while the camera is located in front of the subject, for example at a height half of the body. The reference points may then be marked on the pictures for subsequent supervised deep learning process. Next, the relations and/or proportions of reference points may be determined by defining two base reference points. Once at least one point is defined as a base point, all other points are numbered and all distances between adjacent points in the image and angles of lines created by adjacent points to line the base points are recorded for each particular object and/or participant.

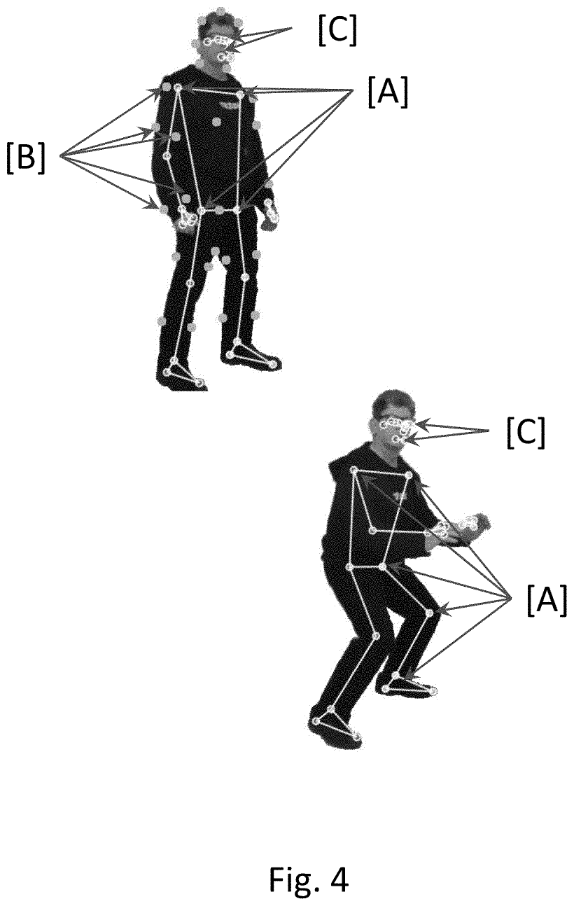

In some embodiments, the training set may be created by taking pictures of the same subjects at different angles and/or marking visible reference points. Reference is made to FIG. 4, which is a schematic illustration of identification of reference points from different angles of the body, according to some embodiments of the invention. While imaging the body, some of the reference points may not be visible.

According to some embodiments, a deep learning model (e.g., a convolutional neural network (CNN)) may be trained to detect all visible reference points based on the prepared images from reference and/or from training sets. Thus, the output may be a model capable of detecting reference points in each frame in a two-dimensional video, either pre-recorded or received from a live camera.

Referring now back to FIG. 2. According to some embodiments, definition of known exercises may be performed where the same exercises are performed by multiple subjects, some of which are professionals, and some of which are just participants doing what the professionals are doing. The sharpness of frame image may be assessed and if the image is not sharp enough, a deblurring algorithm may be applied. The images in video frames may not be sharp enough during, for example a fast movement of the participant.

In some embodiments, visible reference points are detected in each video frame from the imager 202 using the trained deep learning model. Based on pre-recorded distances between the base points, the detected reference points may be scaled, so that the distance between the base points (either visible or calculated based on other reference points) and corresponding to one canonical unit. When the base points are not visible, they may be inferred from other pairs of reference points. The scaling factor is recorded for each frame for subsequent processing, where the scaling causes images taken from different camera distances create the same set of reference points.

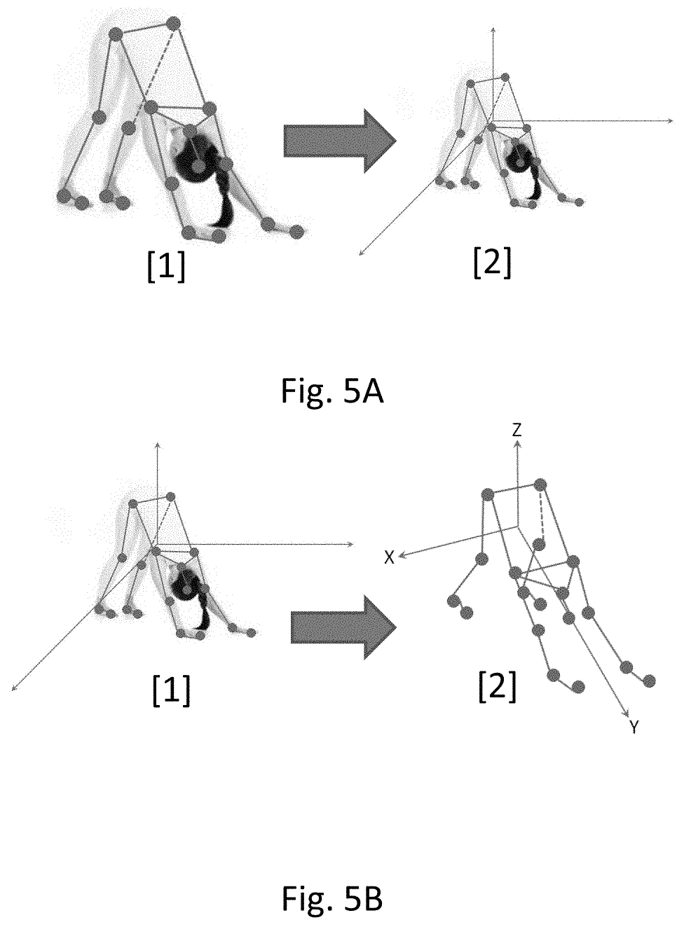

Reference is made to FIGS. 5A-5B, which is a schematic illustration of scaling of reference points to a single canonical unit, according to some embodiments of the invention. In FIG. 5, scaling of the reference points is shown, with only a subset of points shown for clarity of view. The reference points are reduced to canonical proportions at the single canonical unit.

In FIG. 5B, the rotation of axes is shown while the figure itself remains stationary. The result is sets of coordinate triples (x, y, z) for each reference point, while some reference points are parallel to plane Y.

Referring now back to FIG. 2. According to some embodiments, reference points are translated from a flat two-dimensional (2D) image into a three-dimensional (3D) model. A translation method may be self-supervised learning using generative adversarial networks (GAN) algorithms, augmented by geometrical calculation of angles and distances of different reference points. During the translation, the image may be rotated and moved (e.g., as shown in FIG. 5B), so that a preselected reference point is always in the center of coordinate 3D system, and the plane defined by 3 pre-selected reference points is always parallel to plane X-Y.

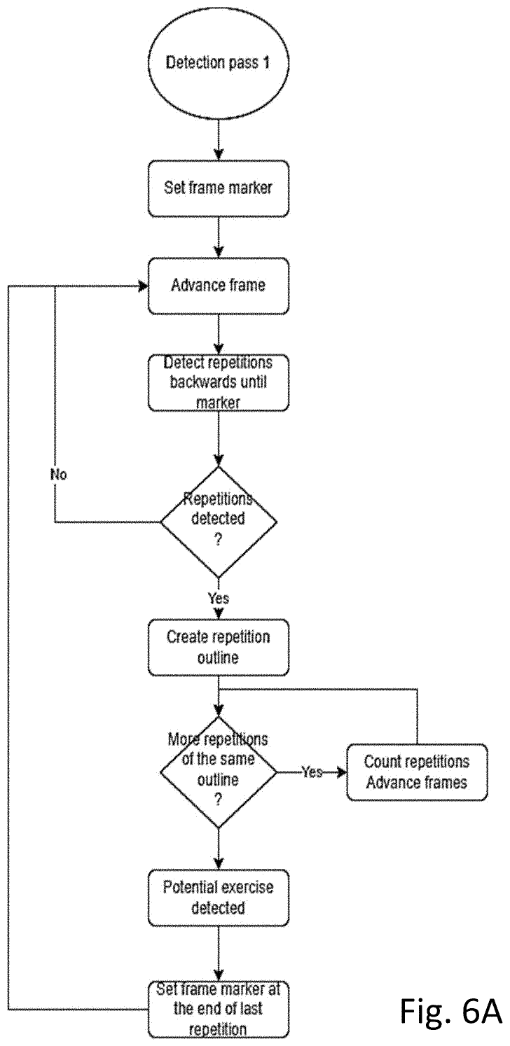

Reference is made to FIGS. 6A-6B, which is a flowchart for an algorithm of identifying a set of frames as a potential exercise, according to some embodiments of the invention. The algorithm may in some instances work offline. In a first pass, exercises of movement may be identifies, and the second pass may determine static poses between the exercises of movement.

In the first pass, a frame marker may be set at the beginning of a video stream, and repetition detection may be initiated. In some embodiments, repetitions may be detected using recurrent neural networks (RNN) or temporal self-similarity matrix (TSM).

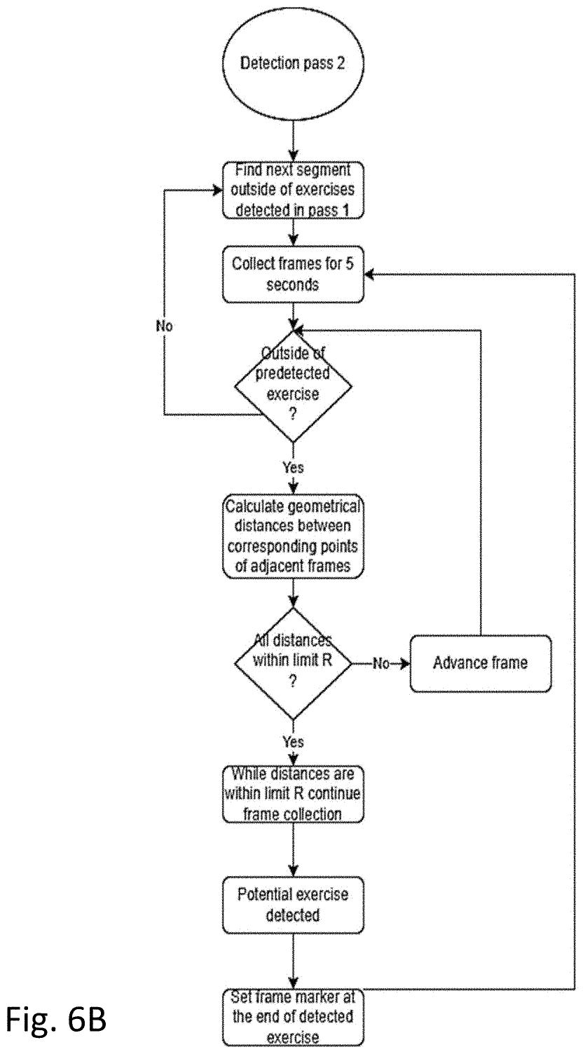

Reference is made to FIGS. 7A-7B, which is a schematic illustration of a repetition outline, according to some embodiments of the invention.

Once two repetitions are detected, a repetition outline is created. In FIG. 7A, partial frames are shown with a subset of reference points marked. In FIG. 7B, the actual repetition outline is shown as determined from the frames, the outline including the reference points (for simplicity only a subset of the points is shown).

In some embodiments, the repetition detection continues as long as it's the repetition of the same sequence (e.g., until the end of the video stream). When the sequence ends, repetition outline is recorded as a potential exercise and the frame marker is set immediately after the end of the last sequence.

In the second pass, a frame marker may be set at the beginning of the first segment outside of the exercises detected in the first pass. The frames may be advanced for five seconds as an example threshold during which the static pose needs to be kept.

The geometrical distances between the corresponding reference points of the adjacent frames may be calculated. For example, the distance between the coordinate location of a base point of adjacent frames may be calculated, then calculating for a different point of adjacent frames, and so on. To be considered a pose, all the distances between the coordinate locations of corresponding points need to be within a limit ‘R’, where ‘R’ may be determined experimentally. ‘R’ may be in the range of 5-7% of the subject (user or participant) scaled or normalized to the maximal height.

In some embodiments, the detection of the pose stops when the subject moves outside of limit ‘R’ in the distances of corresponding reference points. The algorithm may repeat from the next frame after the last pose frame, as long as it's outside of the previously detected exercises.

In some embodiments, some exercises can't be identified using the abovementioned algorithms. For example, an exercise which repeats only one time. Another example may be when the movement to assume a static pose is considered a part of the exercise and needs to be performed in a specific way too, or in case, for example, of a Tai Chi kata, where each movement flows from the previous one, and repeats only once. Such exercises may be identified manually, with the indication of exercise start and end frames, and the exercise outline may be created for the whole indicated sequence.

In some embodiments, the determined exercises may be reviewed by professionals and some of the exercises may be entered into “known exercise dictionary”. Each item in the exercise dictionary may represent one known exercise. For static poses the item may include reference points of a single frame. For exercise involving movement, the dictionary may include the exercise outline. Number of frames in the outline is determined by the average execution duration of the exercise, as performed by multiple times by different performers.

Each reference point in each frame in the dictionary is represented by coordinate triple+set of permitted tolerances. For example, one point may be represented as (−10±1.8, +2±1.3, +8±0.6). Tolerances are determined statistically, during multiple exercise execution instances.

The exercise dictionary may be created with a set of known exercises, for which there's a predefined “correct” execution, and as long as the reference points of exercise execution are within the tolerances defined in the dictionary. The dictionary may be personalized by the practitioner, so that a specific participant may have different tolerances than a dictionary standard. The personalization may be done using a specialized user interface UI, where the outline reference points may be placed on the same image and scale as participant reference points, and the practitioner may pull visually dictionary points (and tolerances) closer to participant reference points.

In some embodiments, at least one of: real human instructor, one or more participants, and instructor avatar at the participant terminal demonstrating the correct execution may be used to correct the participant. The human instructor may be alerted to provide personal attention when the participant consistently does not execute correctly.

For a recorded instructor/trainer pre-recorded video, one or more participants, and instructor avatar at the participant terminal may demonstrate the correct execution and/or correcting the participant.

For practitioner training sessions, an apprentice practitioner training, participant avatar may perform with some random inefficiencies, apprentice practitioner correcting. In some embodiments, the real instructor may be presented as avatar, participant may be presented as another avatar in a virtual scenery, e.g., yoga studio with avatars of other participants, such that the instructor may monitor and/or communicate with the participant.

In all cases the actual detection/correction flow may be executed at the user end-device, such as: laptop, smartphone, tablet, smart TV, etc. Direct data collected through video and/or audio may be augmented with the data from wearable devices: smart watches, bands, etc.

For the purpose of content creation (either live, or recorded) the practitioners may be recommended to use multiple higher quality cameras, to be able to present the execution example from multiple angles simultaneously.

The user's device (e.g., smartphone, laptop, tablet, etc.) may be initialized by connecting to a cloud service and download application software, models, personalized exercise dictionary etc.

Application software may start processing real-time video data of the user, for instance to get image data acquisition. In parallel, the cloud service may provide either live or recorded video data and reference points of the practitioner and optionally other participants. Depending on the configuration it may then optionally create at the user system avatars of the instructor(s) or other participants.

The sharpness of the user's image is analyzed and if needed a deblurring algorithm is applied. In some embodiments, the user's ser reference points are detected, using the same ML model as described herein above.

The system may attempt to detect the exercise performed by the participant. This may be done by checking in the exercise dictionary whether the participant first frames may be correlated with known exercise first frames. At the same time the application may receive exercise detection data from the practitioner. This data may be created on the practitioner or participant device(s) by analyzing her real-time video or it may be indicated in the session plan by specifying the planned exercise before the training session. Exercise data from the practitioner or from other users may be used to create instructor's and other users' avatars. Practitioner data may also be used to assist in detection of a participant exercise.

Once the user exercise is detected, the current frame may be compared to all frames in the exercise outline by calculating sum of distances between the corresponding reference points of the processed video frame and of the outline frames and the closest outline frame is selected.

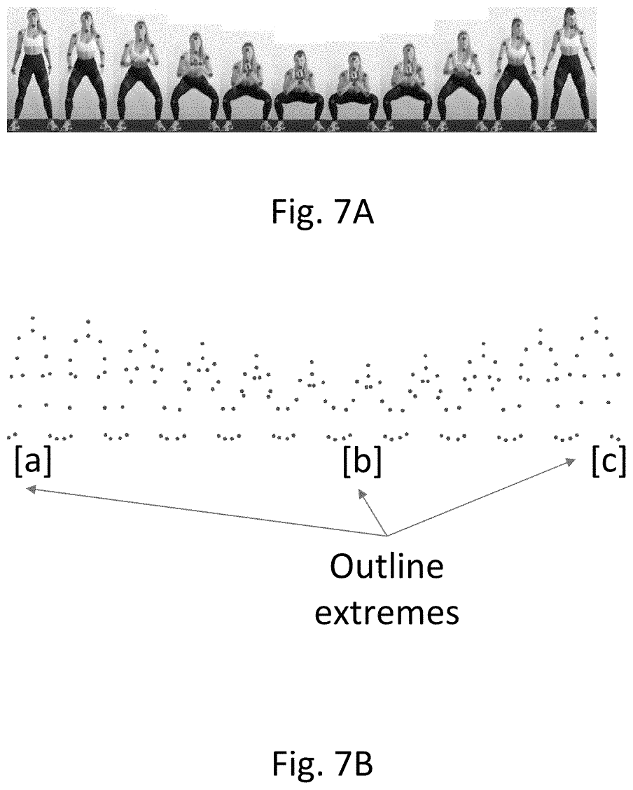

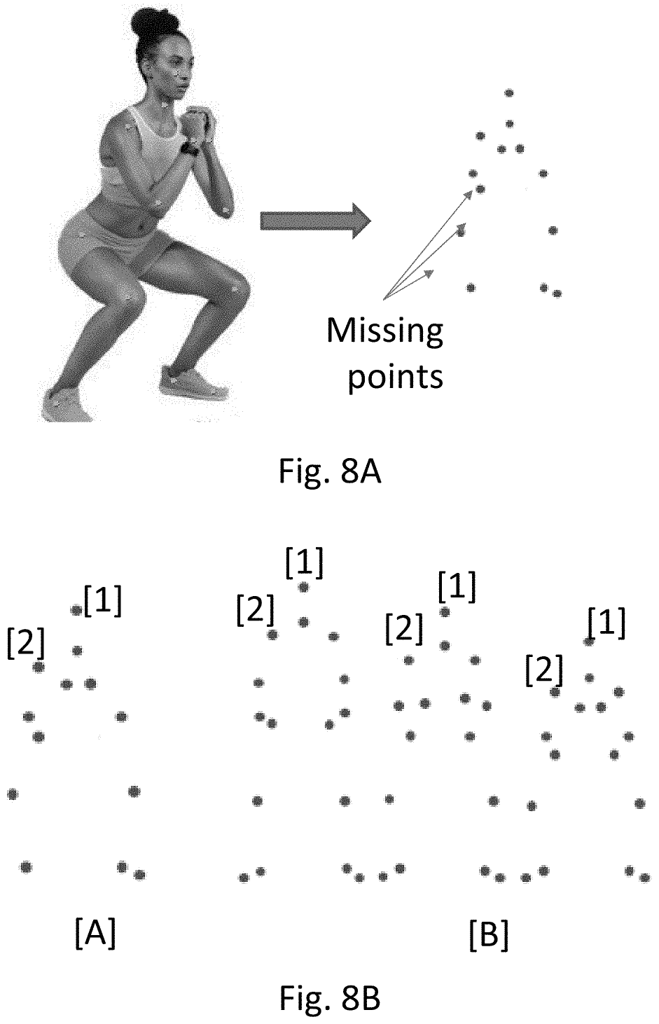

Reference is made to FIG. 8A, which is a schematic illustration of a translation of an image to a subset of points (with some missing points) and FIG. 8B illustrates points to compare, according to some embodiments of the invention. For example, point [1] of frame [A] may be compared to points [1] in all frames of the exercise outline [B]. Once the closest frame is selected, the points are verified to be within the dictionary tolerances.

The deviation from the correct execution may be calculated as a mean distance between the actual frame points and the corresponding points of the outline frame. If the actual reference point is within the tolerances of the outline frame, then the distance between the points is 0.

The deviation of the exercise from the dictionary may be classified into several types, such as incorrect posture, where most of the reference points are outside of the allowed tolerance. Another example is incorrect delineation, where the posture is correct (i.e., central skeleton points are within the tolerance) but the limbs are not placed well. For example, legs open too wide, or the arms are not sufficiently extended.

Another type may include a shortened performance. Actual reference points are within the tolerances of the outline reference points, but the participant never reaches the outline extremes.

The subject of training fatigue and/or training injuries may be controversial. There are publications on how excessive training increases fatigue and/or injuries, and also how the athletes training hard reduce their fatigue & injury risks. However, there's a consensus on two subjects training fatigue and injury risk are very personal, and exaggerated exertion without proper preparation increases both training fatigue and/or risk of injuries.

The system may use its personalized collected data to find optimal conditions for each participant, and lets the practitioner set personalized limits for each participant. Computer vision and ML algorithms may be applied to detect safe ways to train and identifies out of the box most frequently occurring types of training fatigue. For example, for any detected exercise the system keeps a personal outline, similar to the dictionary, created during the first exercise iterations/repetitions. The system detects the extreme points (beginning, end and the highest-exertion point in the middle) and makes sure that the extreme points are reached in all iterations. During the execution, the system may detect that the extreme points stop being reached, and notifies that there's an execution fatigue and that the efficiency of training is reduced. It may recommend to perform a lower number of remaining repetitions, but make sure to reach the extreme points.

Similar to the performance shortening over time, when a participant is in a static pose, the pose may change. The angle of the exercise may change, the back may change its position, and other changes may occur that reduce the stance efficiency. An example of stance change may be a Shotokan Kiba-dachi stance. During training, participants may be required to keep this stance for a long time, and as it becomes progressively more difficult, the angle of the knees is reduced.

Yet another aspect may include identification of muscle tremors. There are many types of tremors the ones indicating training fatigue are “intention tremors” and “postural tremors”. Tremor may be detected by frequent oscillation of some reference points around some pivotal location. Exercise parts where the tremors are most likely to occur are identified by analyzing the exercise performance by many participants and detecting most frequent tremor frame sets within exercise outlines. Tremor may be normal for some short duration (few seconds), but extended tremor may trigger an abnormal condition.

Similarly to training fatigue, injury aversion is highly personal. The system may learn user data over time, analyzes conditions that led to injuries and detects common pre-injury conditions. Incorrect posture, when comparing the execution to the dictionary, the position of the back, the opening angle of the legs and of the knees may be checked. When these parameters significantly deviate from the norm (dictionary) the participant and the practitioner may be notified. The participant and the practitioner may flag current position as “OK”, and the system learns it. After a sufficient learning the system may have a very low level of false positives.

Concentration impairment, where during the session the participant responds to the session commands changes in the exercises, practitioner's directives, system alerts. With time, responses to such commands may become slower. It means that the participant is less concentrated on the session. Lower concentration increases injury risks, so such slower response times are flagged.

Exaggerated flexibility, where in many cases the training requires pushing the limits. However, there are many activities in which pushing the limits significantly increases injury rates. An example of such activity is physiotherapy. The system may detect unusual to the participant joint angles and the practitioner may decide whether to activate this type of detection or not and what the tolerance of the detection should be.

Exaggerated exertion may be defined as increasing the training load by more than X % In a single session. Value of X is configurable, but typically it's 20%. For example, if in a session a typical number of pushups is 100, then suddenly doing more than 120 pushups may be detected as an unusual exertion. The practitioner may decide whether to activate this type of detection or not, and may customize the value of X.

If the participant is using a wearable device (e.g., smart watch, band, etc.) the data collected from these devices may help detect additional anomalies In the extreme it may be a heart condition, but any deviation from normal heart rate (either set as a target or learned over time), saturation or any other reading reported by a wearable device may be used to flag an increased injury risk.

When either inefficiency is detected (e.g., incorrect execution, fatigue condition, etc.), the system may calculate the inefficiency score. The score is calculated by weighted average distance from a correct execution. For each measured parameter, there's a definition of expected value(s), the tolerance, current value and a weight. To normalize different values of different parameters, the percent of deviation of the distance from the tolerance may be measured, using the formula: Dp,q=t/sqrt(sum((Qi−Pi)2)) where ‘P’ and ‘Q’ are the points, the distance between which is being measured, Pᵢ, and Qᵢ are different point dimensions and ‘t’ is the parameter tolerance measured in the distance units.

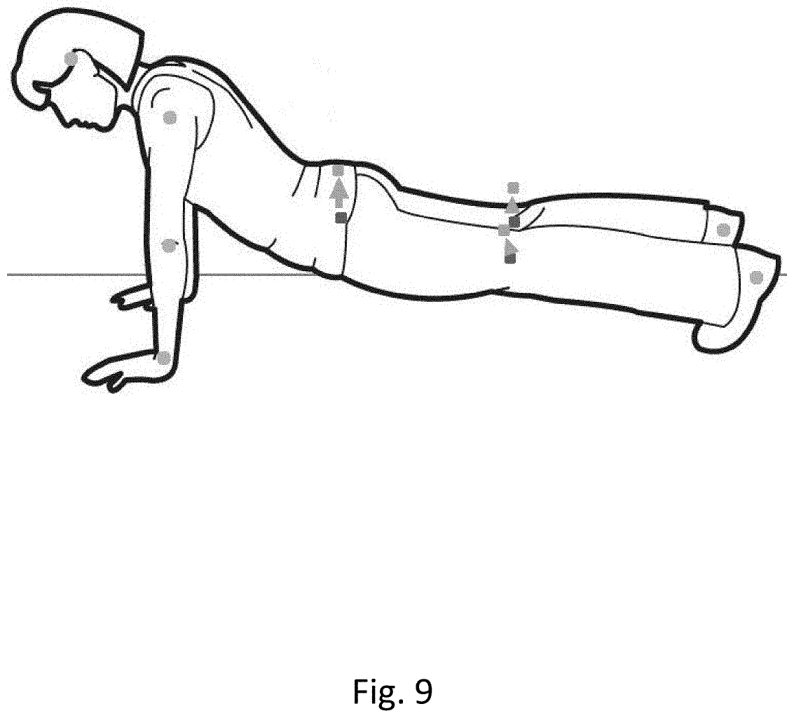

Reference is made to FIG. 9, which is a schematic illustration of a correction suggestion, according to some embodiments of the invention. Inefficiency score may be calculated as weighted average of all distances using: sum(Dᵢ, *Wᵢ)/sum(Wᵢ), where Dᵢ is the deviation percent of parameter i and Wᵢ is the weight of parameter ‘i’. When the inefficiency score crosses the threshold, the system may indicate to the participant that the execution of an exercise is sub-optimal, and may suggest a correction, by showing the “correct” way of execution superimposed on the participant image or avatar.

When an unusual condition is detected, the system may alert the participant and the practitioner. Exercise correction is one example of such alert, but other types of alerts may be a warning, an encouragement, or a strong recommendation to terminate the activity (for example, in case of a heart condition). In most cases, the alert may be shown first to the participant, and if the participant does not amend the situation within some period of time, a prioritized alert is propagated to the practitioner (if the practitioner is present). Alert priority to the practitioner may dement on multitude of factors. Examples of such factors are inefficiency score compared to other participants, alert severity, participant medical condition.

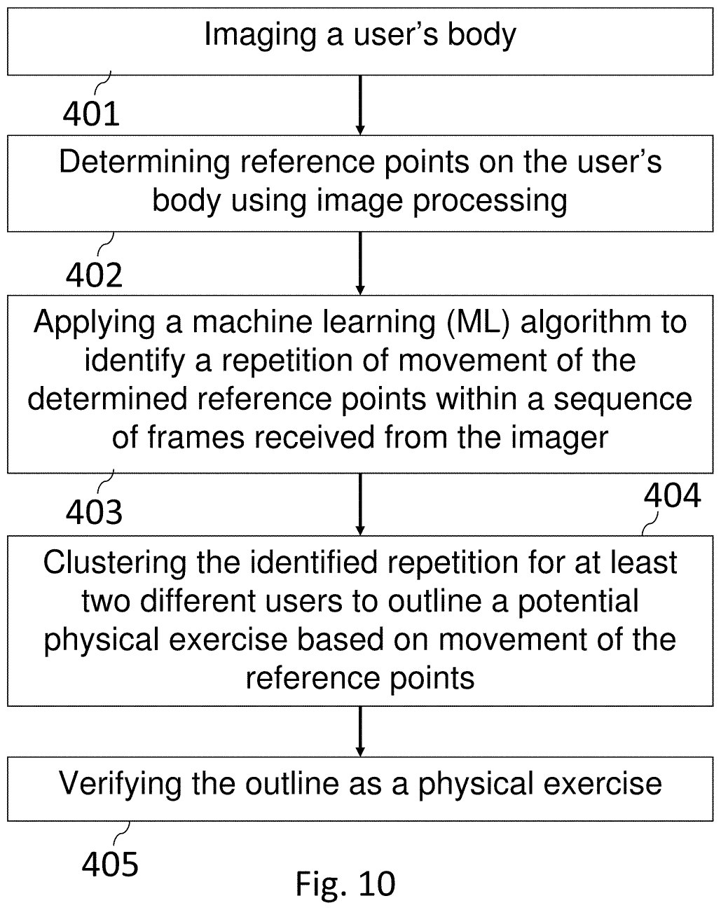

Reference is made to FIG. 10, which is a flowchart for a method of identifying a physical exercise, according to some embodiments of the invention.

The user's body may be imaged 401 by an imager, and reference points may be determined 402 on the user's body using image processing.

A machine learning (ML) algorithm may be applied 403 to identify a repetition of movement of the determined reference points within a sequence of frames received from the imager. The identified repetition may be clustered 404 for at least two different users to outline a potential physical exercise based on movement of the reference points, and the outline may be verified 405 as a physical exercise.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of method of translating a two-dimensional (2D) image into a three-dimensional (3D) model, the method comprising:
imaging, by an imager, a user's body;
determining, by a processor, reference points on the user's body using image processing; and
applying, by the processor, a machine learning (ML) algorithm to translate the determined reference points on a 2D image of the user's body from the imager into a 3D model of the reference points,
wherein the 3D model is determined based on a known relation between the reference points of the user's body.

2. The method of claim 1, wherein the ML algorithm comprises self-supervised learning using a generative adversarial network (GAN) algorithm.

3. The method of claim 1, comprising rotating the 2D image such that a predefined point of the reference points is at the center of a 3D coordinate system.

4. The method of claim 3, comprising scaling the determined reference points so that the distance between each pair of reference points corresponds to the 3D coordinate system.

5. The method of claim 1, wherein the imager is a single RGB camera, and wherein the imaging is carried out to capture images of a plurality of angles of the user's body.

6. A method of identifying a physical exercise, the method comprising:
imaging, by an imager, a user's body;
determining, by a processor, reference points on the user's body using image processing;
applying, by the processor, a machine learning (ML) algorithm to identify a repetition of movement of the determined reference points within a sequence of frames received from the imager;
clustering, by the processor, the identified repetition for at least two different users to outline a potential physical exercise based on movement of the reference points; and
verifying the outline as a physical exercise.

7. The method of claim 6, wherein the ML algorithm is based on at least one of: a recurrent neural network (RNN) and a temporal self-similarity matrix (TSM).

8. The method of claim 6, wherein the ML algorithm is to identify repetition of motionless of the determined reference points within a sequence of frames received from the imager as a potential physical exercise.

9. The method of claim 6, comprising:
receiving instructions for a correct execution of the verified physical exercise;
calculating an inefficiency score based on weighted average distance of the reference points from the correct execution; and
providing a suggestion to correct the user's posture by moving at least one reference point, when the inefficiency score exceeds a posture threshold,
wherein the posture threshold is based on a deviation from a normalized average of different users carrying out the verified physical exercise.

10. The method of claim 6, wherein each verified physical exercise is stored in a dedicated database to be compared to future exercises.

11. The method of claim 10, comprising determining that a new repetition of movement as corresponding to the physical exercise from the dedicated database.

12. The method of claim 6, comprising:
receiving instructions for a correct execution of the verified physical exercise;
determining at least one extreme movement point during the verified physical exercise; and
issuing an alert when the determined at least one extreme movement point is reached below a predefined fatigue threshold.

13. The method of claim 12, comprising issuing an alert when a tremor movement is detected over a predefined time period.

14. The method of claim 12, comprising issuing an alert when at least one of the following conditions is detected incorrect posture, concentration impairment, and exaggerated exertion.

15. The method of claim 12, wherein the predefined fatigue threshold is based on a fatigue database comprising a plurality of conditions, postures, and movements associated with a state of fatigue.
